(19) United States
(12) Patent Application Publication
(10) Pub. No.: US 2021/0295260 A1
(43) Pub. Date: Sep. 23, 2021

(54) PROXIMITY BASED ECOMMERCE RETURNS

(71) Applicant: International Business Machines Corporation, Armonk, NY (US)

(72) Inventors: Zachary A. Silverstein, Jacksonville, FL (US); Lisa Seacat DeLuca, Baltimore, MD (US); Hemant Kumar Sivaswamy, Pune, IN (US)

(21) Appl. No.: 16/822,160

(22) Filed: Mar. 18, 2020

(51) Int. Cl. G06Q 10/08; H04W 4/029

(52) U.S. Cl. CPC G06Q 10/0837; H04W 4/029; G06Q 10/0833; G06Q 10/0836

(57) ABSTRACT

In an approach to managing merchandise returns, one or more computer processors receive a request from a user for return of a first item purchased from store. One or more computer processors retrieve data associated with a supply chain of the store. One or more computer processors retrieve data associated with a delivery of a second item by the store. Based on the request and the retrieved data associated with the supply chain and the delivery, one or more computer processors determine a proximity of the first item to a location on a delivery itinerary of a courier. One or more computer processors retrieve a geolocation on the delivery itinerary within a proximity threshold of the first item. One or more computer processors add a pickup of the first item to the delivery itinerary in association with the retrieved geolocation.

### BACKGROUND OF THE INVENTION

The present invention relates generally to the field of data analytics, and more particularly to managing merchandise returns based on the proximity of an item to a scheduled delivery.

In business and finance, supply chain is a system of organizations, people, activities, information, and resources involved in moving a product or service from supplier to customer. Supply chain activities involve the transformation of natural resources, raw materials, and components into a finished product that is delivered to the end customer.

Electronic commerce (sometimes referred to herein as “eCommerce”) is a growing sector of the U.S. and world economies. As with traditional brick and mortar purchases, eCommerce purchasers sometimes desire to return one or more of the items purchased. A purchaser may want to return the purchased product based on several factors, such as discovering the product to be defective, discovering that the product is not fit for its purpose, and/or discovering that the product was incorrectly described at the time of purchase.

### SUMMARY

Embodiments of the present invention disclose a method, a computer program product, and a system for managing merchandise returns. The method may include one or more computer processors receiving a request from a user for return of a first item purchased from a store. One or more computer processors retrieve data associated with a supply chain of the store. One or more computer processors retrieve data associated with a delivery of a second item by the store. Based on the request and the retrieved data associated with the supply chain and the delivery, one or more computer processors determine a proximity of the first item to a location on a delivery itinerary of a courier. One or more computer processors retrieve a geolocation on the delivery itinerary within a proximity threshold of the first item. One or more computer processors add a pickup of the first item to the delivery itinerary in association with the retrieved geolocation.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a proximity return program, on a server computer within the distributed data processing environment of FIG. 1, for managing merchandise returns based on the proximity of an item to a scheduled delivery, in accordance with an embodiment of the present invention;

FIG. 3 depicts a block diagram of components of the server computer executing the proximity return program within the distributed data processing environment of FIG. 1, in accordance with an embodiment of the present invention.

### DETAILED DESCRIPTION

In an effort to improve customer satisfaction, many business establishments that sell goods, such as eCommerce companies and brick and mortar stores, herein collectively referred to as stores, provide consumers with the flexibility to purchase and return products with no additional shipping charges. The free shipping policy encourages consumers to buy products “at will,” resulting in the consumer returning the products due to reasons such as the product being the wrong size. In order to effectively manage sales and returns, there is a need to streamline both the delivery of product and the collection of products that consumers want to return. An efficient delivery and return system may also reduce the “carbon footprint” of an eCommerce business.

Embodiments of the present invention recognize that efficiency may be gained by implementing a system for merchandise returns based on proximity of a scheduled delivery fulfillment. Implementation of embodiments of the invention may take a variety of forms, and exemplary implementation details are discussed subsequently with reference to the Figures.

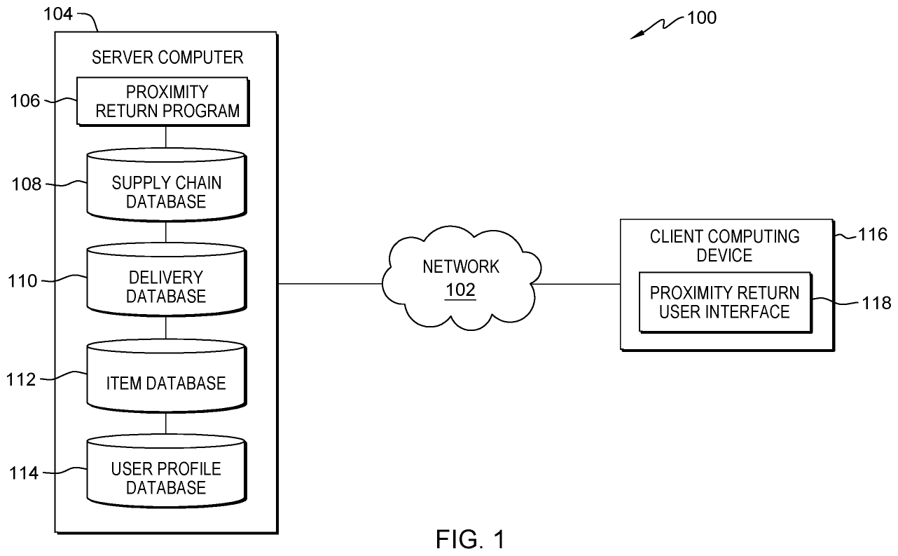

FIG. 1 is a functional block diagram illustrating a distributed data processing environment, generally designated 100, in accordance with one embodiment of the present invention. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes server computer 104 and client computing device 116, interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks capable of receiving and transmitting data, voice, and/or video signals, including multimedia signals that include voice, data, and video information. In general, network 102 can be any combination of connections and protocols that will support communications between server computer 104, client computing device 116, and other computing devices (not shown) within distributed data processing environment 100.

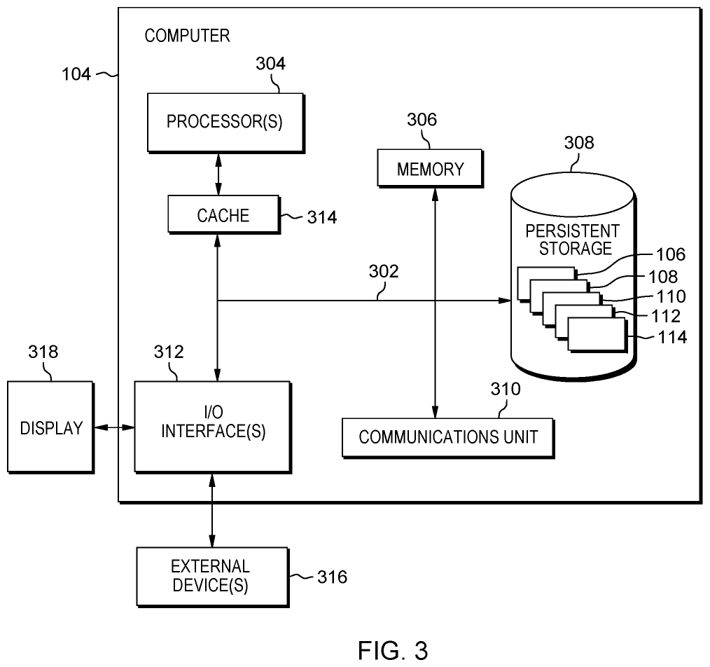

Server computer 104 can be a standalone computing device, a management server, a web server, a mobile computing device, or any other electronic device or computing system capable of receiving, sending, and processing data. In other embodiments, server computer 104 can represent a server computing system utilizing multiple computers as a server system, such as in a cloud computing environment. In another embodiment, server computer 104 can be a laptop computer, a tablet computer, a netbook computer, a personal computer (PC), a desktop computer, a personal digital assistant (PDA), a smart phone, or any programmable electronic device capable of communicating with client computing device 116 and other computing devices (not shown) within distributed data processing environment 100 via network 102. In another embodiment, server computer 104 represents a computing system utilizing clustered computers and components (e.g., database server computers, application server computers, etc.) that act as a single pool of seamless resources when accessed within distributed data processing environment 100. Server computer 104 includes proximity return program 106, supply chain database 108, delivery database 110, item database 112, and user profile database 114. Server computer 104 may include internal and external hardware components, as depicted and described in further detail with respect to FIG. 3.

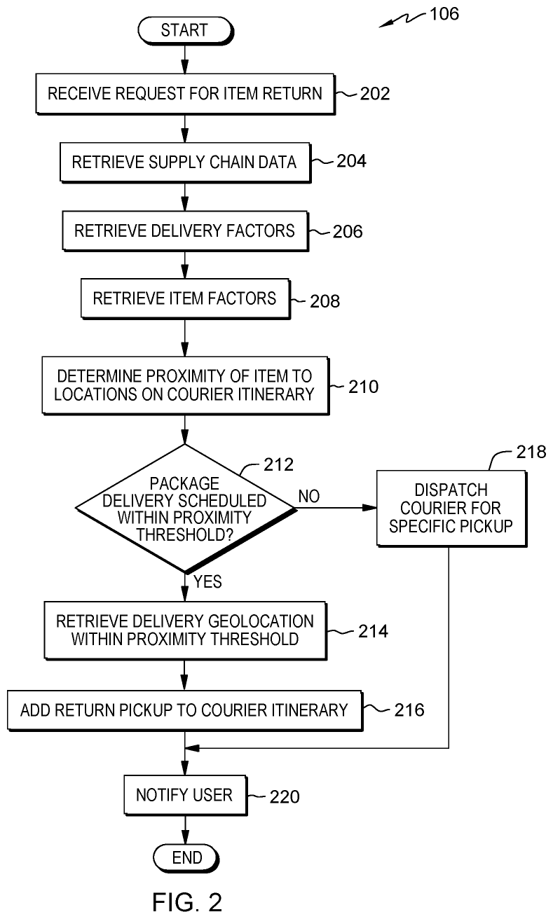

Proximity return program 106 evaluates a request for return of a purchased item and schedules the pickup of the item such that the pickup is within a pre-defined threshold proximity to an already scheduled delivery. Proximity return program 106 receives a request for return of an item. Proximity return program 106 retrieves supply chain data, delivery factors, and item factors. Proximity return program 106 determines a proximity of the item to one or more locations on an itinerary of a delivery courier. Based on the retrieved data and the itinerary of the delivery courier, proximity return program 106 determines whether there is a product delivery scheduled within a proximity threshold of the item to be returned. If there is a product delivery scheduled within a proximity threshold of the item to be returned, then proximity return program 106 retrieves the delivery geolocation that is within the proximity threshold and adds the return pickup to the itinerary of the courier. If there is not a product delivery scheduled within a proximity threshold of the item to be returned, then proximity return program 106 dispatches a second courier specifically for the pickup. Responsive to adding the return pickup to the itinerary of the courier or dispatching a second courier for the pickup, proximity return program 106 notifies the user of the scheduled pickup. Proximity return program 106 is depicted and described in further detail with respect to FIG. 2.

Supply chain database 108, delivery database 110, item database 112, and user profile database 114 are each a repository for data used and generated by proximity return program 106. Supply chain database 108, delivery database 110, item database 112, and user profile database 114 can each represent one or more databases. In the depicted embodiment, supply chain database 108, delivery database 110, item database 112, and user profile database 114 reside on server computer 104. In another embodiment, supply chain database 108, delivery database 110, item database 112, and user profile database 114 may each reside elsewhere within distributed data processing environment 100, provided proximity return program 106 has access to supply chain database 108, delivery database 110, item database 112, and user profile database 114. In the depicted embodiment, supply chain database 108, delivery database 110, item database 112, and user profile database 114 are separate entities. In another embodiment, one or more of supply chain database 108, delivery database 110, item database 112, and user profile database 114 may be included in a combined database. A database is an organized collection of data. Supply chain database 108, delivery database 110, item database 112, and user profile database 114 can each be implemented with any type of storage device capable of storing data and configuration files that can be accessed and utilized by proximity return program 106, such as a database server, a hard disk drive, or a flash memory. Supply chain database 108 stores data related to order fulfillment for a store, for example, orders for items and expected delivery of the items. Delivery database 110 stores factors related to the delivery of ordered items, including, but not limited to, geolocations of the delivery vehicle and of the requested item delivery, distance to be traveled by the delivery vehicle, expected time of delivery, elapsed time of the delivery vehicle to make the delivery, address of the delivery location, including street address, apartment number, floor of a building, etc. Item database 112 stores factors related to the item for which a return is requested, including, but not limited to, a proximity threshold for the return, the urgency of the return, the cost of the item, the price of the item, an existence of other items to be returned by the same user, or by nearby users, a length of time since a return was requested, etc. User profile database 114 stores data associated with the user that requests an item return, including, but not limited to, name, address, phone number, email address, customer loyalty status, social network affiliation, shopping history, etc.

The present invention may contain various accessible data sources, such as supply chain database 108, delivery database 110, item database 112 and user profile database 114, that may include personal data, content, or information the user wishes not to be processed. Personal data includes personally identifying information or sensitive personal information as well as user information, such as tracking or geolocation information. Processing refers to any, automated or unautomated, operation or set of operations such as collection, recording, organization, structuring, storage, adaptation, alteration, retrieval, consultation, use, disclosure by transmission, dissemination, or otherwise making available, combination, restriction, erasure, or destruction performed on personal data. Proximity return program 106 enables the authorized and secure processing of personal data. Proximity return program 106 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. Proximity return program 106 provides information regarding personal data and the nature (e.g., type, scope, purpose, duration, etc.) of the processing. Proximity return program 106 provides the user with copies of stored personal data. Proximity return program 106 allows the correction or completion of incorrect or incomplete personal data. Proximity return program 106 allows the immediate deletion of personal data.

Client computing device 116 can be one or more of a laptop computer, a tablet computer, a smart phone, smart watch, a smart speaker, or any programmable electronic device capable of communicating with various components and devices within distributed data processing environment 100, via network 102. Client computing device 116 may be a wearable computer. Wearable computers are miniature electronic devices that may be worn by the bearer under, with, or on top of clothing, as well as in or connected to glasses, hats, or other accessories. Wearable computers are especially useful for applications that require more complex computational support than merely hardware coded logics. In one embodiment, the wearable computer may be in the form of a head mounted display. The head mounted display may take the form-factor of a pair of glasses. In an embodiment, the wearable computer may be in the form of a smart watch or a smart tattoo. In an embodiment, client computing device 116 may be integrated into a vehicle of the user. For example, client computing device 116 may include a heads-up display in the windshield of the vehicle. In general, client computing device 116 represents one or more programmable electronic devices or combination of programmable electronic devices capable of executing machine readable program instructions and communicating with other computing devices (not shown) within distributed data processing environment 100 via a network, such as network 102. Client computing device 116 includes an instance of proximity return user interface 118.

Proximity return user interface 118 provides an interface between proximity return program 106 on server computer 104 and a user of client computing device 116. In one embodiment, proximity return user interface 118 is mobile application software. Mobile application software, or an “app,” is a computer program designed to run on smart phones, tablet computers and other mobile devices. In one embodiment, proximity return user interface 118 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. Proximity return user interface 118 enables a user of client computing device 116 to input user profile data and item return information, such as make, model, and serial number of the item, and a pickup location. Proximity return user interface 118 may also enable a user of client computing device 116 to receive and view a notification generated by proximity return program 106.

FIG. 2 is a flowchart depicting operational steps of proximity return program 106, on server computer 104 within distributed data processing environment 100 of FIG. 1, for managing merchandise returns based on the proximity of an item to a scheduled delivery, in accordance with an embodiment of the present invention.

Proximity return program 106 receives a request for item return (step 202). A user of client computing device 116 opts in to use proximity return program 106 by registering and inputting user profile information into proximity return user interface 118. When a user decides to return an item purchased from a store, the user requests the return via proximity return user interface 118, and proximity return program 106 receives the request.

Proximity return program 106 retrieves supply chain data (step 204). In an embodiment, proximity return program 106 retrieves supply chain data from supply chain database 108, i.e., data related to order fulfillment for the store from which the user requested the item return, for example, orders for items and scheduled delivery dates and/or times of the items in an area surrounding the geolocation of either the user or of a pickup location specified by the user. In an embodiment, the area surrounding the geolocation of the user may be pre-defined. For example, the area may be the state in which the user resides, or the postal code in which the user resides. In an embodiment, proximity return program 106 creates clusters of scheduled delivery locations in order to locate an area surrounding the return geolocation.

Proximity return program 106 retrieves delivery factors (step 206). In an embodiment, proximity return program 106 retrieves delivery factors from delivery database 110. Delivery factors are related to the delivery of items ordered from the store, including, but not limited to, geolocations of the delivery vehicle and of the requested item delivery, distance to be traveled by the delivery vehicle, expected time of delivery, elapsed time of the delivery vehicle to make the delivery, address of the delivery location, including street address, apartment number, floor of a building, etc.

Proximity return program 106 retrieves item factors (step 208). In an embodiment, proximity return program 106 retrieves item factors from item database 112, user profile database 114, or both. Item factors relate to the item for which the user has requested a return and can influence the scheduling of a return pickup. Item factors may include, but are not limited to, an urgency of the return, the cost, price, or value of the item, a profit margin on the item, an existence of other items to be returned by the same user, or by nearby users, a length of time since a return was requested, and a size of the item which necessitates available space in a delivery vehicle. The status of the user in the loyalty program of the store may also be an item factor. For example, if the user has been a member of the loyalty program for a pre-defined period of time, the user may be entitled to a faster return pickup than a user that is not a member of the loyalty program. A reputation of the user as an influencer or celebrity may also be an item factor. For example, the user may be known to post negative consumer experiences on social media, which may cause the store to prioritize the scheduling of a return pickup.

Proximity return program 106 determines a proximity of the item to be returned to locations on an itinerary of a delivery courier (step 210). In an embodiment, proximity may be a distance radius, for example, a number of miles, blocks, floors of an apartment building, etc. In another embodiment, proximity may be a travel time, for example, a five-minute drive. In another embodiment, the proximity threshold may include both a distance radius and a travel time. In an embodiment, proximity return program 106 determines the proximity using one or more known techniques. For example, proximity return program 106 may use a global positioning service (GPS) to determine a distance radius or travel time between a location of the courier and the location of the item to be returned.

Proximity return program 106 determines whether there is a package delivery scheduled within a proximity threshold (decision block 212). In an embodiment, a proximity threshold is a pre-defined distance radius and/or travel time within which a courier's delivery efficiency is not adversely affected by the addition of a return pickup. For example, in a large city, a proximity threshold may be within a five-block radius of a scheduled delivery, whereas in a rural area, a proximity threshold may be within a five-mile radius of a scheduled delivery. In another example, a proximity threshold in a city may be within a ten-minute drive of a scheduled delivery, whereas in a rural area, a proximity threshold may be within a 30-minute drive of a scheduled delivery. In an embodiment where the proximity threshold includes both a pre-defined distance and a travel time, proximity return program 106 may require one or both conditions to be satisfied in determining whether there is a package delivery scheduled within a proximity threshold. In an embodiment, proximity return program 106 may dynamically adjust the proximity threshold based on one or more item factors, as described with respect to step 208. For example, a proximity threshold may be within a five-block radius of a scheduled delivery, however if the user that requested the return is a member of a loyalty program of the store, then proximity return program 106 may adjust the proximity threshold to be larger in an effort to provide priority service to the user. In another example, proximity return program 106 may increase or reduce the proximity threshold based on the cost, price, or value of the item to be returned, such that proximity return program 106 uses a larger proximity threshold for a high value item, such as a laptop, and a smaller proximity threshold for a low value item, such as a pair of shoes. In a further example, proximity return program 106 may increase the proximity threshold such that if a user requested to return the item over a threshold amount of time, such as two months ago, then proximity return program 106 prioritizes the request. In yet another example, proximity return program 106 may increase the proximity threshold to include an item for which inventory is currently low and additional orders exist. In another example, proximity return program 106 may reduce the proximity threshold if proximity return program 106 determines that there will not be enough space in the delivery vehicle for the returned item at the time that the delivery vehicle is in proximity to the location of the item to be returned.

If proximity return program 106 determines there is a package delivery scheduled within a proximity threshold (“yes” branch, decision block 212), then proximity return program 106 retrieves a geolocation of a scheduled delivery within the proximity threshold (step 214). In an embodiment, proximity return program 106 retrieves a geolocation of a scheduled delivery from delivery database 110. In an embodiment, proximity return program 106 retrieves a GPS location of a scheduled delivery. In another embodiment, proximity return program 106 retrieves an itinerary of a courier within the proximity threshold which indicates addresses of scheduled deliveries. In an embodiment, if more than one geolocation of a scheduled delivery is within the proximity threshold, proximity return program 106 may retrieve more than one geolocation.

Proximity return program 106 adds an item return pickup to the itinerary of the courier (step 216). In an embodiment, proximity return program 106 adds the item to be returned to the itinerary of the courier whose route includes at least one delivery within the proximity threshold in association with the retrieved geolocation. Proximity return program 106 adds the geolocation of the item to be returned into the itinerary either before or after the scheduled delivery location. In an embodiment, proximity return program 106 may place the geolocation of the item to be returned in the itinerary of the courier after the scheduled delivery in the proximity threshold in order to create space in the delivery vehicle for the item. In an embodiment, proximity return program 106 may insert the geolocation of the item to be returned in the itinerary in a position which is not adjacent to the closest scheduled delivery location if proximity return program 106 determines a different position in the itinerary may be more efficient. For example, if the location of the item to be returned is on one side of a one way street, and the scheduled delivery location is on the other side of the one way street, directly across from the location of the item to be returned, then proximity return program 106 may determine that it may be more efficient to pick up the return after a scheduled delivery that requires the courier to turn around, even if that location is further down the one way street. In an embodiment, proximity return program 106 notifies the courier that a return has been added to the itinerary. In an embodiment, if proximity return program 106 retrieved more than one geolocation of a scheduled delivery, then proximity return program 106 may notify the courier of the plurality of geolocations and enable the courier to select one.

If proximity return program 106 determines there is not a package delivery scheduled within a proximity threshold (“no” branch, decision block 212), then proximity return program 106 dispatches a second courier specifically for the pickup (step 218). In an embodiment, proximity return program 106 may retrieve a plurality of delivery schedules from supply chain database 108 and determine that there are no deliveries scheduled within the proximity threshold. In this scenario, proximity return program 106 dispatches a courier specifically to pick up the item to be returned. In an embodiment, in response to receiving a request for an item return, proximity return program 106 continually monitors delivery schedules to determine whether there is a delivery within the proximity threshold. In the embodiment, if proximity return program 106 determines there is not a delivery scheduled within a threshold duration of time included in the proximity threshold, then proximity return program 106 dispatches a courier to pick up the item to be returned.

In another embodiment, proximity return program 106 retrieves supply chain data and delivery factors and determines whether there is a package delivery scheduled within a proximity threshold (decision block 212) based on the retrieved supply chain data and delivery factors. Responsive to determining there is not a package delivery scheduled within a proximity threshold (“no” branch, decision block 212), proximity return program 106 retrieves item factors and determines whether to adjust the proximity threshold based on the retrieved item factors. For example, proximity return program 106 may determine, based on supply chain data and delivery factors, that there is no scheduled delivery in the proximity threshold of the user that requested the return, however proximity return program 106 determines that, based on the membership of the user in the store loyalty program, the user is entitled to a pickup within a week of the request. Therefore, proximity return program 106 adjusts the proximity threshold to include the requested pickup in a scheduled delivery itinerary within the week.

Responsive to adding an item return pickup to the itinerary of the courier or dispatching a second courier for the specific pickup, proximity return program 106 notifies the user of the scheduled pickup (step 220). Once proximity return program 106 schedules the return pickup, proximity return program 106 notifies the user of the schedule via proximity return user interface 118. In an embodiment, proximity return program 106 includes instructions in the notification regarding the pickup. For example, instructions may include a specific location for placement of the item. In another example, instructions may include a specific time for the item to be available for pickup. In a further example, instructions may include a requirement that the user be present for the pickup. In another embodiment, proximity return program 106 may include in the notification a request to access the user's schedule or calendar in order to choose a convenient time for item pickup. In an embodiment, proximity return program 106 may simultaneously utilize more than one means to notify the user to ensure the user receives the notification. For example, using data stored in user profile database 114, proximity return program 106 may send one notification via text message and another notification via a phone call. In an embodiment, proximity return program 106 may include a list of courier itineraries in the notification and request the user to select an itinerary from the list to which proximity return program 106 adds the return pickup.

The following is an example scenario which describes the operation of proximity return program 106. In the example, user 1 purchases a pair of shoes from a store. Upon receipt of the pair of shoes, user 1 determines the shoes do not fit properly and contacts the store to request a return pickup. The store, via proximity return program 106, adds this request to one or more other requests previously received by proximity return program 106. Proximity return program 106 determines that the store has sufficient inventory of the shoes that user 1 wants to return and adjusts the proximity threshold such that the pickup of the pair of shoes is a low priority. After two weeks have passed, user 2 purchases a tennis racquet from the store. Proximity return program 106 determines that the location of user 2 is within the proximity threshold of user 1, and adds the pickup of the pair of shoes from user 1 to the itinerary of the courier that is scheduled to deliver the tennis racquet to user 2 such that the courier picks up the pair of shoes immediately after delivering the tennis racquet.

FIG. 3 depicts a block diagram of components of server computer 104 within distributed data processing environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

Server computer 104 can include processor(s) 304, cache 314, memory 306, persistent storage 308, communications unit 310, input/output (I/O) interface(s) 312 and communications fabric 302. Communications fabric 302 provides communications between cache 314, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer readable storage media. In this embodiment, memory 306 includes random access memory (RAM). In general, memory 306 can include any suitable volatile or non-volatile computer readable storage media. Cache 314 is a fast memory that enhances the performance of processor(s) 304 by holding recently accessed data, and data near recently accessed data, from memory 306.

Program instructions and data used to practice embodiments of the present invention, e.g., proximity return program 106, supply chain database 108, delivery database 110, and item database 112, are stored in persistent storage 308 for execution and/or access by one or more of the respective processor(s) 304 of server computer 104 via cache 314. In this embodiment, persistent storage 308 includes a magnetic hard disk drive. Alternatively, or in addition to a magnetic hard disk drive, persistent storage 308 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices, including resources of client computing device 116. In these examples, communications unit 310 includes one or more network interface cards. Communications unit 310 may provide communications through the use of either or both physical and wireless communications links. Proximity return program 106, supply chain database 108, delivery database 110, item database 112, and other programs and data used for implementation of the present invention, may be downloaded to persistent storage 308 of server computer 104 through communications unit 310.

I/O interface(s) 312 allows for input and output of data with other devices that may be connected to server computer 104. For example, I/O interface(s) 312 may provide a connection to external device(s) 316 such as a keyboard, a keypad, a touch screen, a microphone, a digital camera, and/or some other suitable input device. External device(s) 316 can also include portable computer readable storage media such as, for example, thumb drives, portable optical or magnetic disks, and memory cards. Software and data used to practice embodiments of the present invention, e.g., proximity return program 106, supply chain database 108, delivery database 110, and item database 112 on server computer 104, can be stored on such portable computer readable storage media and can be loaded onto persistent storage 308 via I/O interface(s) 312. I/O interface(s) 312 also connect to a display 318.

Display 318 provides a mechanism to display data to a user and may be, for example, a computer monitor. Display 318 can also function as a touch screen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method, the method comprising:
receiving, by one or more computer processors, a request from a user for return of a first item purchased from a store;
retrieving, by one or more computer processors, data associated with a supply chain of the store;
retrieving, by one or more computer processors, data associated with a delivery of a second item by the store;
based on the request, the retrieved data associated with the supply chain, and the retrieved data associated with the delivery, determining, by one or more computer processors, a proximity of the first item to a location on a delivery itinerary of a first courier of the store;
retrieving, by one or more computer processors, a geolocation on the delivery itinerary within a proximity threshold of the first item; and
adding, by one or more computer processors, a pickup of the first item to the delivery itinerary in association with the retrieved geolocation.

2. The method of claim 1, further comprising:
retrieving, by one or more computer processors, data associated with the first item, wherein the data associated with the first item is selected from the group consisting of: an urgency of the return, a cost of the first item, a price of the first item, a value of the first item, a profit margin on the first item, an existence of one or more other items to be returned by the user, an existence of one or more other items to be returned by nearby users, a length of time since the return was requested, a size of the item, a status of the user in a loyalty program of the store, and a reputation of the user; and
adjusting, by one or more computer processors, the proximity threshold based on the data associated with the first item.

3. The method of claim 1, further comprising, notifying, by one or more computer processors, the user of a scheduled pickup of the first item.

4. The method of claim 3, wherein notifying the user of the scheduled pickup includes data selected from the group consisting of: instructions of a specific location for placement of the first item, instructions of a specific time for the first item to be available for the scheduled pickup, a requirement that the user be present for the scheduled pickup, and a request to access to a schedule of the user.

5. The method of claim 1, wherein the proximity threshold is selected from the group consisting of a pre-defined distance radius and a pre-defined travel time.

6. The method of claim 1, wherein the data associated with the supply chain of the store is selected from the group consisting of: an order for one or more items, a scheduled delivery date of one or more items, and a scheduled delivery time of one or more items.

7. The method of claim 1, wherein the data associated with the delivery of the second item is selected from the group consisting of: a geolocation of a delivery vehicle, a geolocation of a delivery, a distance to be traveled by a delivery vehicle, an expected time of delivery, an elapsed time of a delivery vehicle to make the delivery, and an address of a delivery location.

8. The method of claim 1, further comprising:
determining, by one or more computer processors, a geolocation on the delivery itinerary is not within a proximity threshold of a third item; and
dispatching, by one or more computer processors, a second courier to pick up the third item.

9. A computer program product, the computer program product comprising:
one or more computer readable storage media and program instructions collectively stored on the one or more computer readable storage media, the stored program instructions comprising:
program instructions to receive a request from a user for return of a first item purchased from a store;
program instructions to retrieve data associated with a supply chain of the store;
program instructions to retrieve data associated with a delivery of a second item by the store;
based on the request, the retrieved data associated with the supply chain, and the retrieved data associated with the delivery, program instructions to determine a proximity of the first item to a location on a delivery itinerary of a first courier of the store;
program instructions to retrieve a geolocation on the delivery itinerary within a proximity threshold of the first item; and
program instructions to add a pickup of the first item to the delivery itinerary in association with the retrieved geolocation.

10. The computer program product of claim 9, the stored program instructions further comprising:
program instructions to retrieve by one or more computer processors, data associated with the first item, wherein the data associated with the first item is selected from the group consisting of: an urgency of the return, a cost of the first item, a price of the first item, a value of the first item, a profit margin on the first item, an existence of one or more other items to be returned by the user, an existence of one or more other items to be returned by nearby users, a length of time since the return was requested, a size of the item, a status of the user in a loyalty program of the store, and a reputation of the user; and
program instructions to adjust the proximity threshold based on the data associated with the first item.

11. The computer program product of claim 9, the stored program instructions further comprising, program instructions to notify the user of a scheduled pickup of the first item.

12. The computer program product of claim 11, wherein program instructions to notify the user of the scheduled pickup includes data selected from the group consisting of: instructions of a specific location for placement of the first item, instructions of a specific time for the first item to be available for the scheduled pickup, a requirement that the user be present for the scheduled pickup, and a request to access to a schedule of the user.

13. The computer program product of claim 9, wherein the proximity threshold is selected from the group consisting of a pre-defined distance radius and a pre-defined travel time.

14. The computer program product of claim 9, the stored program instructions further comprising:
program instructions to determine a geolocation on the delivery itinerary is not within a proximity threshold of a third item; and
program instructions to dispatch a second courier to pick up the third item.

15. A computer system, the computer system comprising:
one or more computer processors;
one or more computer readable storage media;
program instructions collectively stored on the one or more computer readable storage media for execution by at least one of the one or more computer processors, the stored program instructions comprising:
program instructions to receive a request from a user for return of a first item purchased from a store;
program instructions to retrieve data associated with a supply chain of the store;
program instructions to retrieve data associated with a delivery of a second item by the store;
based on the request, the retrieved data associated with the supply chain, and the retrieved data associated with the delivery, program instructions to determine a proximity of the first item to a location on a delivery itinerary of a first courier of the store;
program instructions to retrieve a geolocation on the delivery itinerary within a proximity threshold of the first item; and
program instructions to add a pickup of the first item to the delivery itinerary in association with the retrieved geolocation.

16. The computer system of claim 15, the stored program instructions further comprising:
program instructions to retrieve by one or more computer processors, data associated with the first item, wherein the data associated with the first item is selected from the group consisting of: an urgency of the return, a cost of the first item, a price of the first item, a value of the first item, a profit margin on the first item, an existence of one or more other items to be returned by the user, an existence of one or more other items to be returned by nearby users, a length of time since the return was requested, a size of the item, a status of the user in a loyalty program of the store, and a reputation of the user; and
program instructions to adjust the proximity threshold based on the data associated with the first item.

17. The computer system of claim 15, the stored program instructions further comprising, program instructions to notify the user of a scheduled pickup of the first item.

18. The computer system of claim 17, wherein program instructions to notify the user of the scheduled pickup includes data selected from the group consisting of: instructions of a specific location for placement of the first item, instructions of a specific time for the first item to be available for the scheduled pickup, a requirement that the user be present for the scheduled pickup, and a request to access to a schedule of the user.

19. The computer system of claim 15, wherein the proximity threshold is selected from the group consisting of a pre-defined distance radius and a pre-defined travel time.

20. The computer system of claim 15, the stored program instructions further comprising:
program instructions to determine a geolocation on the delivery itinerary is not within a proximity threshold of a third item; and
program instructions to dispatch a second courier to pick up the third item.
